(19) United States
(12) Patent Application Publication
(10) Pub. No.: US 2017/0019062 A1
(43) Pub. Date: Jan. 19, 2017

(54) SOLAR POWERED FILMING HARNESS

(71) Applicant: Greg Delacerda, West Hollywood, CA (US)

(72) Inventor: Greg Delacerda, West Hollywood, CA (US)

(21) Appl. No.: 15/213,248

(22) Filed: Jul. 18, 2016

Related U.S. Application Data
(60) Provisional application No. 62/193,810, filed on Jul. 17, 2015.

(51) Int. Cl. H02S 20/30; H02J 7/35; A41D 27/20; A41D 1/04; A41D 1/00; H02S 20/00; H02J 3/38

(52) U.S. Cl. CPC H02S 20/30; H02S 20/00; H02J 7/355; H02J 3/383; A41D 1/04; A41D 1/002; A41D 27/205

(57) ABSTRACT

A solar-powered harness comprises a retention pocket for holding a mobile device including a camera configured for capturing images, the retention pocket capable of securely retaining the camera while the camera is capturing images, at least one solar panel, affixed to the solar-powered harness, the solar panel configured for generating electrical current when exposed to solar rays, and a retention channel configured to securely maintain electrically conductive wires in communication with the mobile device and the solar panel so as to enable the solar panel to provide the electrical current to the mobile device while the camera is capturing images.

### RELATED APPLICATION INFORMATION

This patent claims priority from U.S. Provisional Patent Application No. 62/193,810 filed Jul. 17, 2015 and entitled “Sports Harness”.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

Field

This disclosure relates to a solar-powered harness. More particularly, a solar-powered harness for temporary storage of a mobile device including a camera that enables a wearer to simultaneously film and charge his or her mobile device while doing so.

Description of the Related Art

There exist solar-powered charging systems and battery packs that may self-charge using solar power. Similarly, there exist film systems, like the GoPro® cameras that are designed to be mounted to sticks, poles, snowboards, helmets, surfboards, and the like.

However, virtually every individual in the world currently possesses a telephone that includes a camera of some type. Modern smart phones common across the U.S., Southeast Asia, and Europe include cameras that are of extremely-high quality. Simultaneously, these smart phones include batteries that can last from 2 to 24 hours of use.

However, as any modern smart phone user knows, activities like constant streaming of video, constant filming of video, or GPS location capabilities rapidly deplete battery stores. In only slightly-older smart phones whose batteries have been used through many power cycles, batteries in use can last less than an hour of constant use.

### DESCRIPTION OF THE DRAWINGS

FIG. 1 is a front view of a solar-powered harness.

FIG. 2 is a back view of a solar-powered harness.

FIG. 3 is a back view of an alternative solar powered harness.

FIG. 4 is a close-up view of a retention pocket on the front of a solar-powered harness.

FIG. 5 is a close-up view of an alternative retention pocket on the front of a solar-powered harness.

FIG. 6 is a close-up view of a solar panel on the back of a solar-powered harness.

FIG. 7 is a close-up view of an alternative solar panel configuration on the back of a solar-powered harness.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Description of Apparatus

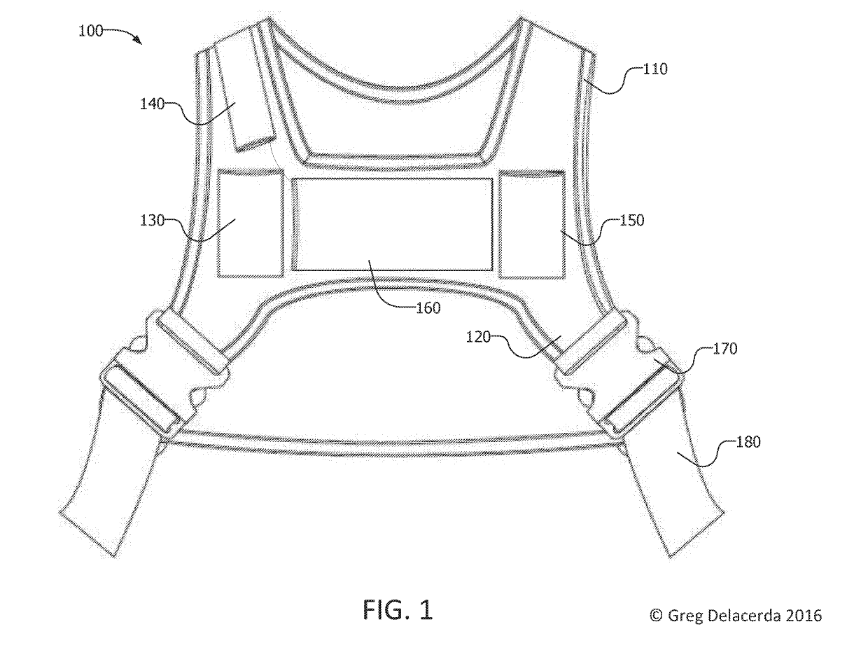

Referring now to FIG. 1 a front view of a solar-powered harness 100 is shown. The harness 100 may be made with reinforced stitching 110. The harness 100 includes a front 120, a first storage pocket 130, a retention channel 140, a second storage pocket 150, a retention pocket 160, a set of clips 170 and adjustable straps 180.

The harness 100 may be made of neoprene, cloth, leather, Kevlar®, or other synthetic or natural materials. The harness 100 may be designed to be water tight or may be designed to allow water to penetrate the harness 100 while maintaining its shape and fit.

The reinforced stitching 110 may be used to ensure that the harness is useful under more-extreme conditions under which a wearer may wish to use the harness 100. For example, the harness 100 may be used while surfing, mountain biking, snowboarding, mountain climbing, scuba diving, or snorkeling. These environments can be harsh on clothing unless it is reinforced. As such, multiple stitching may be used and seams may be reinforced with additional material sewn over the seams. This reinforced stitching may be used on only those seams making up the harness 100 itself or may be used for all of the pockets, channels, and straps described herein as well.

The front 120 is designed to be worn on the front of a human chest and includes a series of elements, discussed below. The front 120 of the harness 100 shown is intended for use by a male. As can be seen, its lower portion would sit rather high on a chest, with its lower seam falling somewhere mid-rib-cage for a typical male. A similar harness 100 front 120 designed for a female may be designed in a form much more-like that of a sports bra, such that its lower seam would fall slightly lower so as to be more comfortable for a woman.

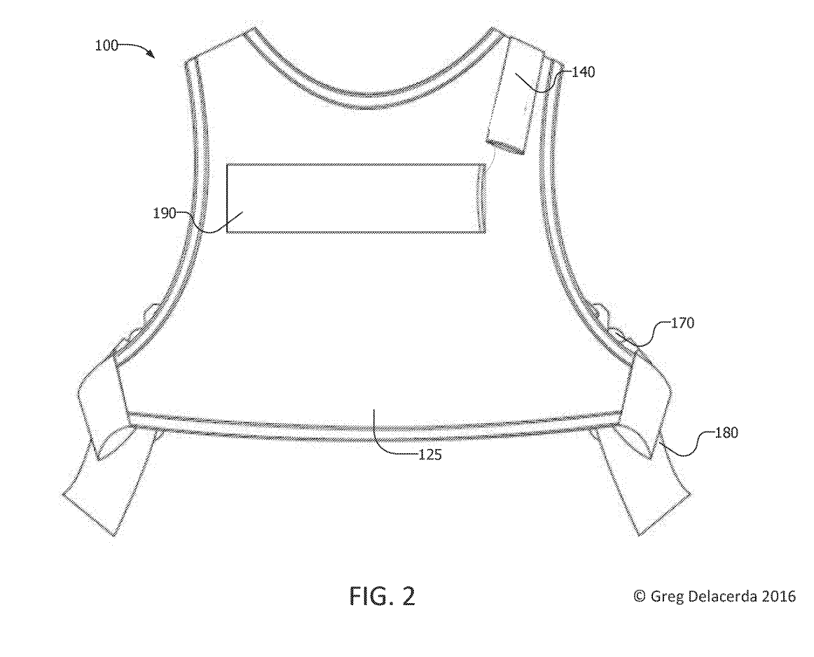

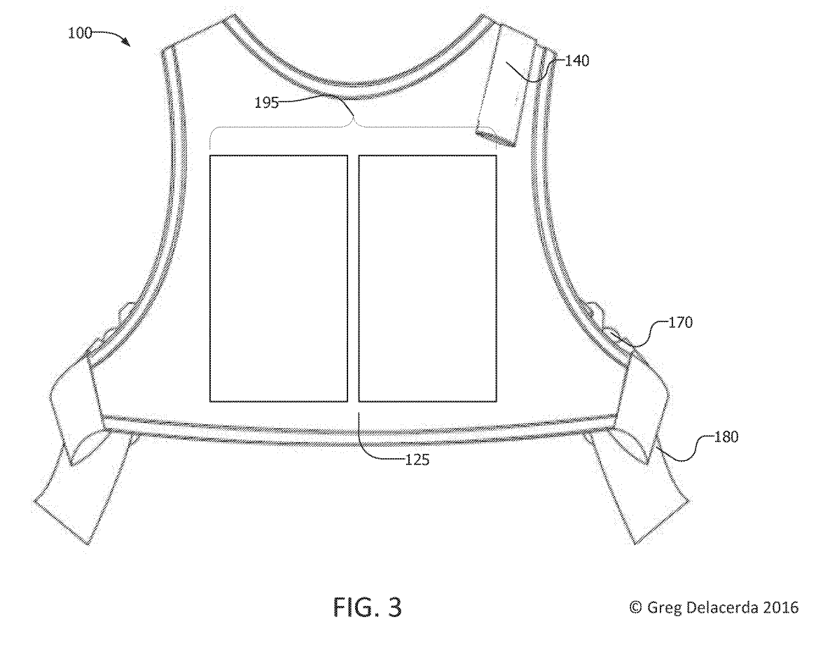

The first pocket 130 and second pocket 150 may be used as utility pockets for storing virtually anything desired by a wearer, subject only to their size. For example, the first pocket 130 and second pocket 150 may include a closure, such as Velcro®, a snap, a button, a clip, or the like suitable for closing the pockets 130, 150 and retaining things within. The first pocket 130 and second pocket 150 may or may not be water tight, when closed using the closure. The first pocket 130 and second pocket 150 may each store, for example, an additional battery that may also be electrically connected to a rear solar panel 190, 195 (See FIGS. 2 and 3) for charging such that a mobile device within the harness 100 may have access to a much larger store of power than its own batteries alone.

A retention channel 140 is a channel of fabric, for example, made by folding a length of fabric in on itself and sewing along its base, closest to the harness 100, to thereby create a channel, through which long, flexible items such as cords or tubes may be passed. Although not shown, the retention channel 140 may be sewn into the material of the harness 100 itself such that it appears only as an inlet and an outlet on the front 120 and back 125 (See FIG. 2) of the harness 100. Still further, the retention channel 140 may be sewn or otherwise formed in the interior of the harness 100 such that no aspect of the retention channel 140 is visible from the exterior of the harness.

The retention channel 140 is designed to enable a mobile device stored within a central retention pocket 160 to be electrically connected to the one or more rear solar panels 190, 195 (See FIGS. 2 and 3) while stored within the retention pocket 160. So, the retention channel 140 can take many forms. As shown, the retention channel 140 is external to the harness 100 and passes over one shoulder strap thereof from front to rear.

The retention pocket 160 is designed to securely hold a mobile device within, while that mobile device is or may be filming using an internal camera. Although a mobile device herein is generally intended to mean a smart phone, it may include devices that are only cameras or have limited functionality other than being a camera. However all mobile devices include, at least, a camera and a battery for powering the camera that may be charged using the solar panels 190, 195 (See FIGS. 2 and 3).

The retention pocket 160, as described in more detail below, may be water tight, may include a closure such as Velcro®, a snap, a button, a clip, or the like suitable for closing the retention pocket 160 and retaining a mobile device therein, and further may be made, in whole or in part, of a transparent or semi-transparent material. Alternatively, the retention pocket 160 may include a cutout or other “hole” through which the camera of the mobile device may film while the mobile device is within the retention pocket. The retention pocket 160 is designed in such a way that filming may take place while the mobile device is retained safely, and hands-free, within the retention pocket 160.

The retention channel 140 is shown in FIG. 1 as not connecting directly to the retention pocket 160. However, in some cases, the retention channel 140 may connect directly to the retention pocket 160 or may be internal to the harness 100 and open within the retention pocket 160. This may be done, for example, to maintain the safety of the mobile device and other electrically-active components in a watertight environment.

The harness 100 also includes a set of clips 170 and adjustable straps 180 to enable a wearer to tighten the harness 100 to their body. The harness 100 is shown as including two clips 170 and straps 180, but fewer or more clips 170 and straps 180 may be used. Also, although clips 170 are shown, other methods of securing the harness 100 to a wearer may be used.

FIG. 2 is a back view of a solar-powered harness 100. The back 125 of the harness 100 includes the retention channel 140, the clips 170 and straps 180 and a solar panel 190 mounted centrally on an upper portion of the panel 125. The retention channel 140, clips 170 and straps 180 have been described above. That description will not be repeated here.

However, the retention channel 140 may, as described above, be internal or external to the harness 100 and may, if desired, connect directly to the solar panel 190. As shown, conductive wires within the retention channel 140 may be connected externally to the harness 100, but other, for example, water tight, embodiments are also envisioned where conductive wires do not meet the exterior of the harness 100 or any water-exposed element of the harness 100 at all.

The solar panel 190 is preferably a self-contained, water tight unit. Conductive wires may already be hard-wired into the solar panel 190 or the solar panel 190 may include an outlet for removable connection to conductive wires for transmitting the associated power to a mobile device in the retention pocket 160 (FIG. 1).

The solar panel 190 is designed to translate photonic energy into electrical current. Solar panels, like solar panel 190, rely upon photovoltaic cells to convert the photonic energy from the sun and other sources into electrical current. Solar panels of a suitable size for inclusion on the back of the harness 100 may provide insufficient power to maintain the full charge of a mobile device in constant use. However, efficiency of solar panels is rapidly increasing and, as discussed above, the inclusion of additional built-in power (e.g., batteries) in the first and second pockets 130, 150 may enable the harness 100 to continue operating the mobile device long beyond its typical operating time on its own battery power while filming.

FIG. 3 is a back view of an alternative solar powered harness 100. The same back panel 125, retention channel 140, clips 170 and straps 180 are shown. Their description will not be repeated. However, here, the harness 100 includes two solar panels 195 spaced horizontally next to each other across a broader area of the panel 125 than the first-described solar panel 190. It may be desirable to incorporate multiple panels for several reasons. First, more surface-area for solar panels increases the amount of current generated linearly. Second, using multiple panels, rather than a single panel, decreases the likelihood that the panel(s) will break because they more-easily conform to the shape of the wearer's body and, should the wearer fall, are less-likely to crack and be damaged irreparably. The present application contemplates one or more solar panels, chosen to result in a balance of flexibility/durability and minimal electrical connections. Two to four solar panels is believed most desirable. For example, two large, present-day solar panels or four smaller solar panels can provide 15 watts of current at 2 amperes.

Although the solar panels 195 are shown on the back panel 125, solar panels may be included on the front of the harness as well or, in some cases, on other pieces of associated clothing such as a hat or on sleeves of a jacket, so long as those other pieces of clothing are in electrical communication with the retention channel 140 and the mobile device within the retention pocket 160.

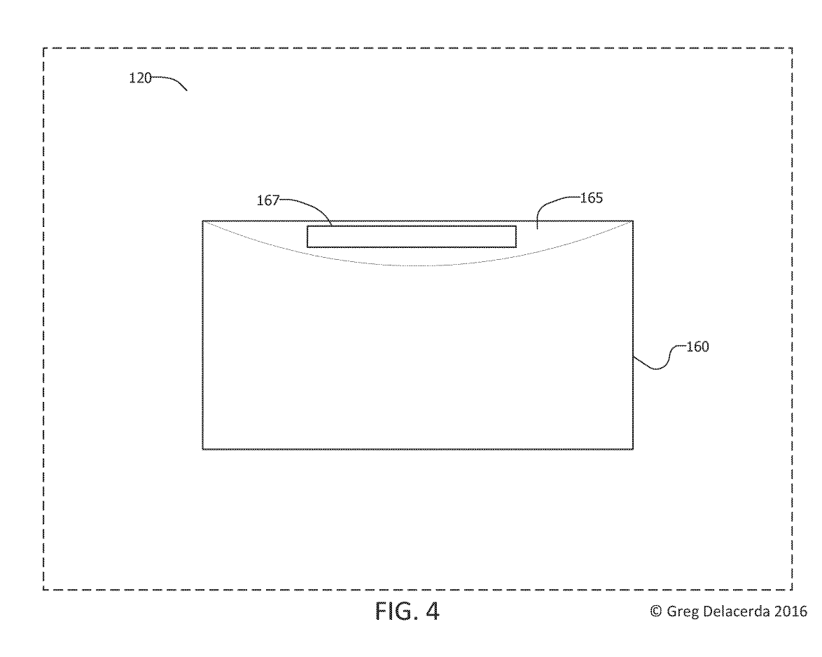

FIG. 4 is a close-up view of a retention pocket 160 on the front 120 of a solar-powered harness 100. The retention pocket 160 may have an opening 165 in the top of the retention pocket 160. The opening may enable a mobile device to be inserted or to be removed from the retention pocket 160. Similarly, a closure 167 may be used to retain a mobile device securely within the retention pocket 160. Here, the closure 167 is shown as Velcro®, but various other closure types may be used, as discussed above.

Although not clearly shown, the retention pocket 160 itself may be removably affixed to the exterior of the front 120 of the harness 100. For example, the entire retention pocket 160 may be affixed to the exterior of the front 120 of the harness 100 by Velcro® such that the retention pocket 160 may be removed without opening the closure 167 of the opening 165 or removing any mobile device from the retention pocket 160. When removed, the retention pocket 160 may be designed in such a way that capacitive touch or other user interaction may be translated to a mobile device within the retention pocket 160.

For example, a mobile device within the retention pocket 160 may be visible through transparent plastic on the back of the retention pocket 160 once removed from the harness 100. Then, a user may interact with the mobile device while it is within the retention pocket 160. In cases in which the retention pocket 160 is water tight, this may be particularly helpful while, for example, a wearer is snowboarding, snorkeling, or otherwise in an environment that may not be suitable to remove the mobile device from the retention pocket 160, but during which interaction is desirable.

The retention pocket 160 shown in FIG. 4 may be made, entirely, of a transparent plastic or similar material, such that the mobile device may film the exterior environment while within the retention pocket 160.

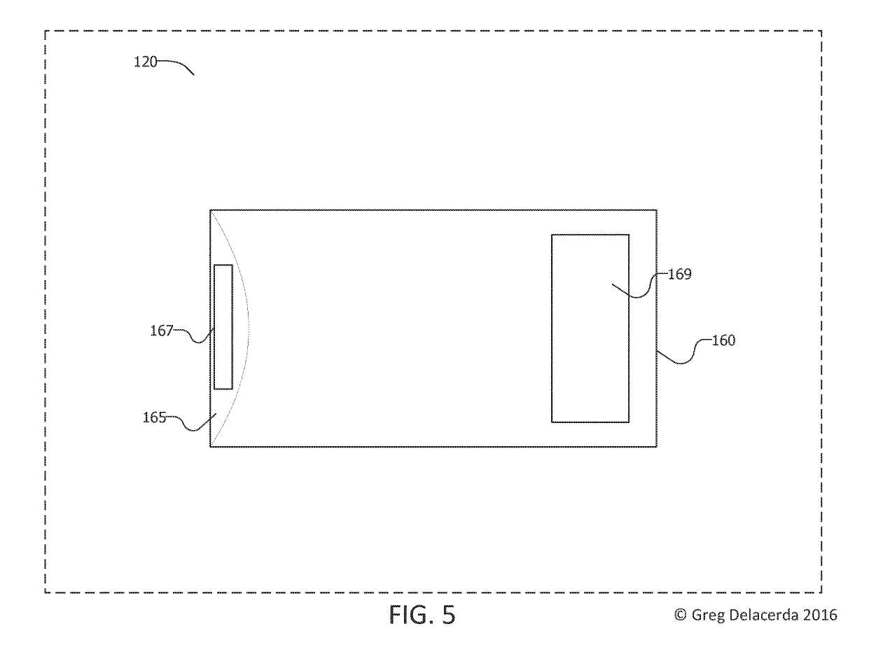

FIG. 5 is a close-up view of an alternative retention pocket 160 on the front 120 of a solar-powered harness 100. This retention pocket 160 has an opening 165 on its left side with a suitable closure 167 also on the left. The description of these elements will not be repeated.

However, the retention pocket 160 in this example may be made of a non-transparent material. As such, a cutout 169 is shown. This cutout may actually be a hole in the fabric exposing the mobile device (and in particular its camera lens) to the exterior environment, while being small enough to ensure that the mobile device does not simply fall out of the retention pocket 160. However, the cutout may instead be a built-in hole that is filled or covered with a transparent material. This may be particularly helpful for version of the harness 100 designed to include the water tight retention pocket 160.

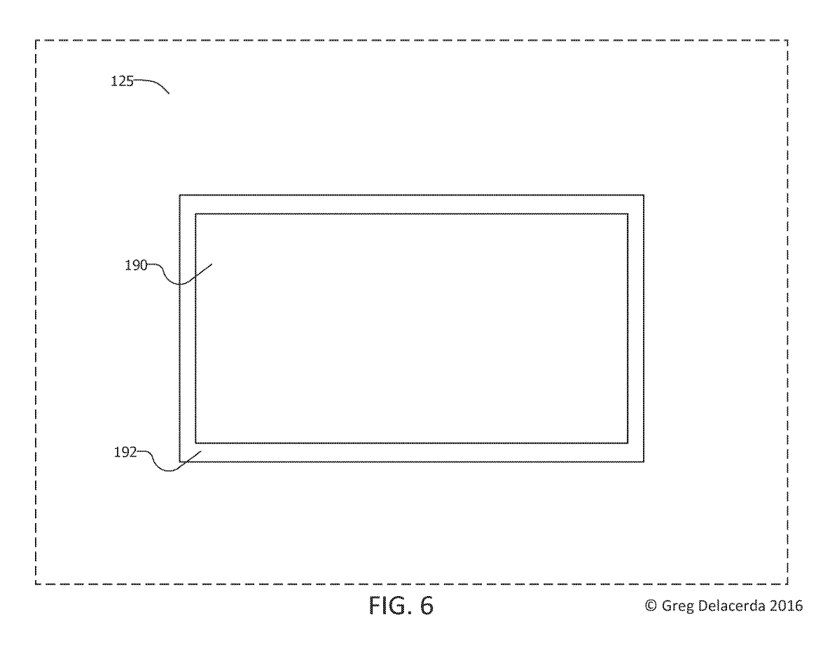

FIG. 6 is a close-up view of a solar panel 190 on the back panel 125 of a solar-powered harness 100. The solar panel 190 may be sewn into the back 125 using reinforced stitching 192 as described above. In some embodiments, however, the solar panel 190 may also be removably affixed, similar to that described above with respect to the retention pocket 160. For example, the solar panel 190 may be affixed by Velcro® such that replacement solar panels (for example, should one cease to function) may be obtained. To this end, the exterior of the harness 100 may include a series of Velcro® or other attachment systems whereby one or more solar panels 190 may be removably affixed. The inclusion of one or more solar panels (or other pockets) may enable the harness 100 to provide more storage, to provide more current, or to otherwise function better or longer, depending on a wearer's needs.

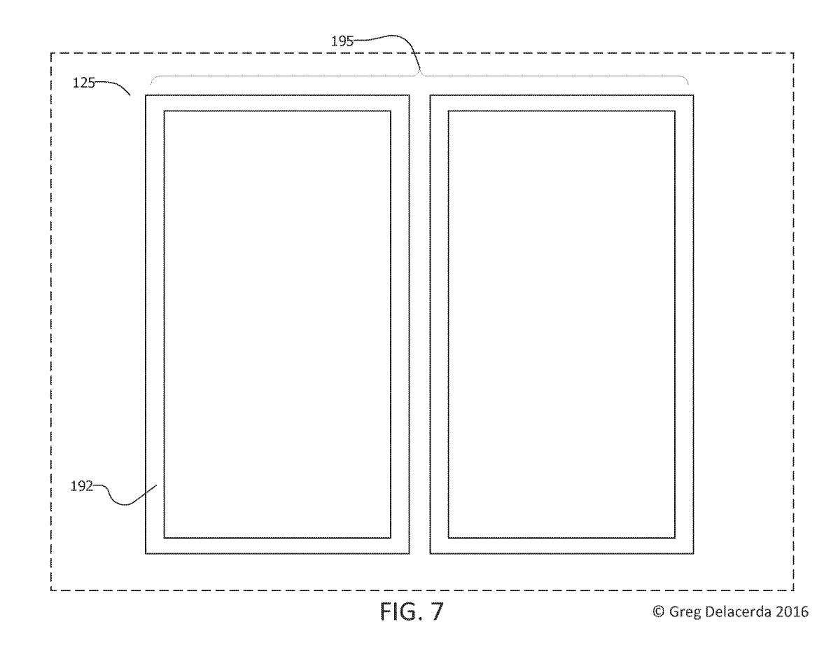

FIG. 7 is a close-up view of an alternative solar panel 195 configuration on the back panel 125 of a solar-powered harness 100. Here, multiple solar panels 195 are shown. These panels 195 may be affixed permanently with reinforced stitching 192 or may be removable as described above.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A solar-powered harness comprising:
a retention pocket for holding a mobile device including a camera configured for capturing images, the retention pocket capable of securely retaining the camera while the camera is capturing images;
at least one solar panel, affixed to the solar-powered harness, the solar panel configured for generating electrical current when exposed to solar rays; and
a retention channel configured to securely maintain electrically conductive wires in communication with the mobile device and the solar panel so as to enable the solar panel to provide the electrical current to the mobile device while the camera is capturing images.

2. The solar-powered harness of claim 1 wherein an exterior of the retention pocket is made of a transparent or semi-transparent material such that the camera may capture images while within the first retention pocket.

3. The solar-powered harness of claim 1 wherein an exterior of the retention pocket includes a cutout suitable to enable the camera to capture images while within the first retention pocket through the cutout.

4. The solar-powered harness of claim 1 where in the electrical current provided by the at least one solar panel is sufficient to maintain the camera capturing images indefinitely while the at least one solar panel is exposed to solar rays.

5. The solar-powered harness of claim 1 wherein the at least one solar panel is permanently fixed to the solar-powered harness.

6. The solar-powered harness of claim 1 wherein the at least one solar panel is removably fixed to the solar powered harness.

7. The solar-powered harness of claim 6 where the at least one solar panel is removably fixed to the solar powered harness by a selected one of: Velcro®, snaps, zippers, clips, retention within pockets designed for the at least one solar panel, and frames in the solar-powered harness designed to interface with the at least one solar panel.

8. The solar-powered harness of claim 1 wherein the retention channel is permanently sewn into the fabric of the solar-powered harness.

9. The solar-powered harness of claim 8 wherein the retention channel is not visible on the exterior of the solar-powered harness.

10. The solar-powered harness of claim 9 wherein the electrically conductive wires are permanently sewn into the retention channel.

11. The solar-powered harness of claim 1 wherein the retention channel is visible on the exterior of the solar-powered harness.

12. The solar-powered harness of claim 11 wherein the electrical conductive wires may be removed from the retention channel.

13. The solar-powered harness of claim 1 further comprising at least one additional storage pocket.

14. The solar-powered harness of claim 1 further comprising at least one adjustable strap suitable for altering the fit of the solar-powered harness on a wearer.

15. A solar-powered harness suitable for removable wear by a human, the solar-powered harness comprising:
a retention pocket for holding a mobile device including a camera configured for capturing images, the retention pocket including a closure capable of securely retaining the camera while the camera is capturing images;
at least one solar panel, affixed to the exterior of the solar-powered harness, the solar panel configured for generating electrical current when exposed to solar rays;
a retention channel configured to securely maintain electrically conductive wires in communication with the mobile device and the solar panel so as to enable the solar panel to provide the electrical current to the mobile device while the camera is capturing images; and
conductive wires within the retention channel configured for simultaneous connection to the at least one solar panel and to the mobile device.

16. The solar-powered harness of claim 15 wherein the retention pocket is configured such that while the remote device is within the retention pocket, the camera may continue filming exterior to the solar-powered harness.

17. The solar-powered harness of claim 15 wherein the retention pocket is removably affixed to the solar-powered harness.

18. The solar-powered harness of claim 17 wherein the retention pocket is configured such that, when the retention pocket is removed from the solar-powered harness, an individual may interact with the mobile device without removing the mobile device from the retention pocket.

19. The solar-powered harness of claim 15 further comprising at least one adjustable strap suitable for altering the fit of the solar-powered harness on a wearer.

20. A solar-powered harness system comprising:
a solar-powereed harness comprising:
a retention pocket for holding a mobile device including a camera configured for capturing images, the retention pocket capable of securely retaining the camera while the camera is capturing images;
at least one solar panel, affixed to the solar-powered harness, the solar panel configured for generating electrical current when exposed to solar rays;
a retention channel configured to securely maintain electrically conductive wires in communication with the mobile device and the solar panel so as to enable the solar panel to provide the electrical current to the mobile device while the camera is capturing images; and
the mobile device including the camera, the mobile device secured within the retention pocket and connected to the at least one solar panel by the electrically conductive wires within the retention channel.
